(19) United States
(12) Patent Application Publication
(10) Pub. No.: US 2012/0331477 A1
(43) Pub. Date: Dec. 27, 2012

(54) SYSTEM AND METHOD FOR DYNAMICALLY ALLOCATING HIGH-QUALITY AND LOW-QUALITY FACILITY ASSETS AT THE DATACENTER LEVEL

(76) Inventors: Roy Zeighami, McKinney, TX (US); Thomas Edwin Turicchi, JR., Dallas, TX (US)

(21) Appl. No.: 13/387,041

(22) PCT Filed: Feb. 18, 2010
(86) PCT No.: PCT/US2010/024511

§ 371 Date: Jan. 25, 2012

(51) Int. Cl. G06F 9/50

(52) U.S. Cl. 718/104

(57) ABSTRACT

A system and method are disclosed for dynamically allocating high-quality and low-quality facility assets at the datacenter level. The system and method provide an actuator with information on priorities of information technology (IT) workloads. The actuator ranks the IT workloads according to their priorities, monitors an amount of resources the IT workloads demand, and tracks total capacities of facility assets in the datacenter. The facility assets include high-quality facility assets and low-quality facility assets. According to the direction of the actuator, a distribution mechanism dynamically switches lower priority IT workloads from the high-quality facility assets to the low-quality facility assets when the high-quality facility assets are overburdened.

### BACKGROUND

Facilities at datacenters provide power and cooling to information technology (IT) workloads. Currently the facilities blindly provide power and cooling as a pooled resource. In other words, power and cooling as well as IT workloads are pooled at the datacenter level, and power and cooling are blindly delivered to the IT workloads without awareness of priority. As shown in FIG. 1, high quality facility assets 110, such, as UPS power, are delivered to pooled, opaque IT workloads 120 indiscriminately. The facilities have no mechanism to enforce certain conditions necessary for them to offer assurances of service levels. For example, current facilities have no mechanism to make sure that IT does not overload the uninterrupted power supply (UPS) system. Likewise, a similar issue exists with air conditioning (A/C) capacity.

Specifically, current datacenters are provisioned with a certain amount of power and cooling and rely on IT consumers to not over-subscribe. Likewise, the facilities must be over-provisioned to deal with failures. High-priority and low-priority workloads are treated equally. That leads to poorer quality of service (QOS) for the high-priority work and burdening of costs for the low-priority work.

### DESCRIPTION OF THE DRAWINGS

The detailed description will refer to the following drawings in which like numbers refer to like objects, and in which:

FIG. 1 illustrates a prior art system for allocating facility assets to Information technology (IT) workloads;

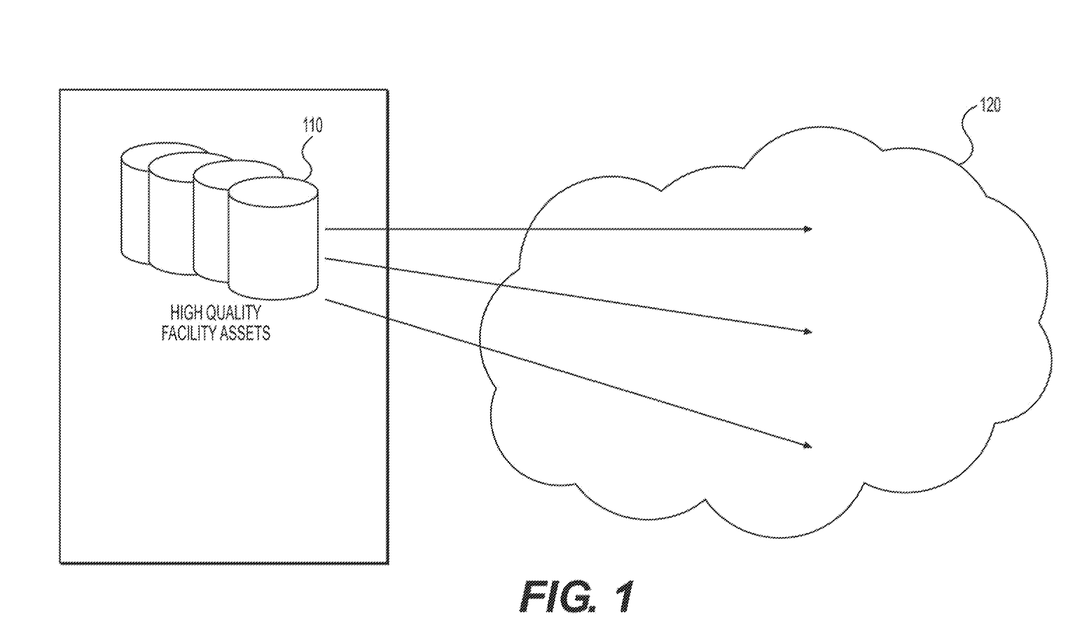

FIGS. 2A and 2B illustrate a single tier datacenter statically allocating high-quality facility assets to all workloads;

FIG. 3 illustrates a multi-tier datacenter statically mapping facility assets and workloads;

FIGS. 4A and 4B illustrate an embodiment of a system for dynamically allocating high-quality and low-quality facility assets at the datacenter level;

FIG. 5 illustrates another embodiment of the system for dynamically allocating high-quality and low-quality facility assets at the datacenter level;

FIG. 6 is a flow chart illustrating an embodiment of a method for dynamically allocating high-quality and low-quality facility assets at the datacenter level; and

FIG. 7 illustrates exemplary hardware components of a computer that may be used in connection with the method for dynamically allocating high-quality and low-quality facility assets at the datacenter level.

### DETAILED DESCRIPTION

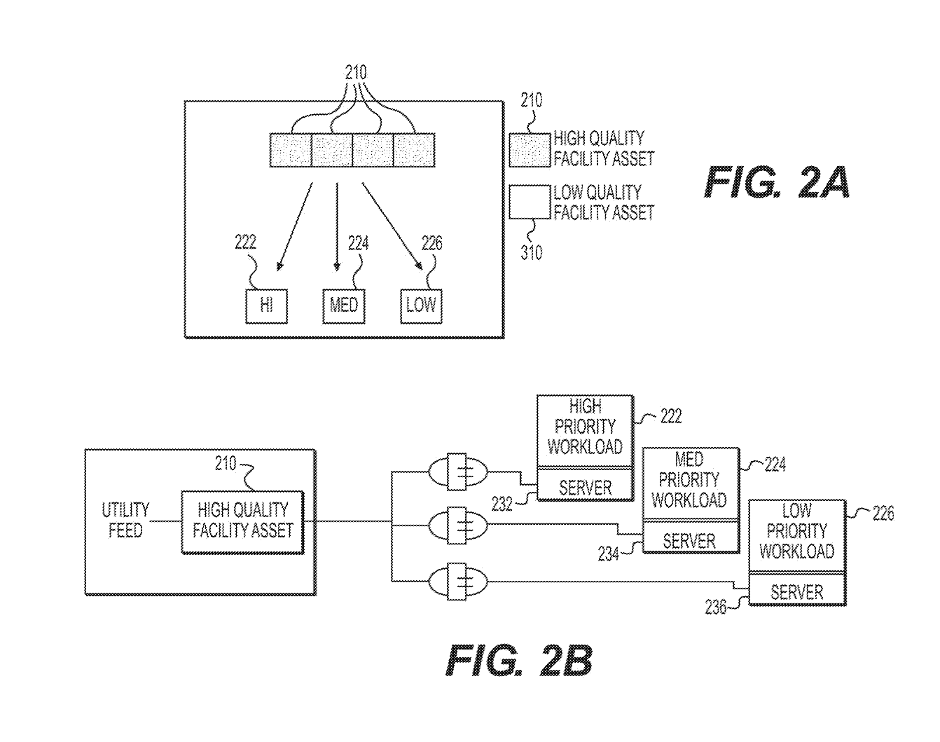

As noted above, currently there is a lack of coordination and awareness between the facilities at the datacenter that provide power and cooling and the information technology (IT) workloads that obtain power and cooling from the facilities. Such a lack of coordination and awareness has been dealt with through conservative provisioning and operating. For example, as shown in FIGS. 2A and 2B, a single tier datacenter statically allocates high-quality (i.e., high-cost) facility assets 210 to all workloads, including high-priority workload 222, medium-priority workload 224, and low-priority workload 226, and their respective servers, 232, 234, 236. This infrastructure may lead to under-utilization and waste.

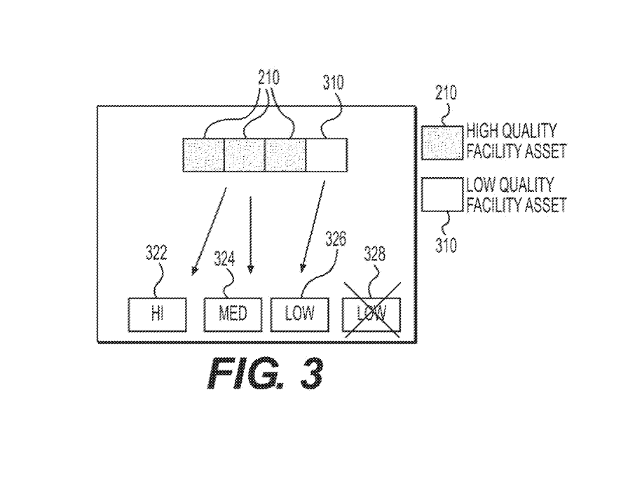

A single datacenter that allows for multiple service levels, i.e., multi-tier datacenter, may provide for cost saving. For example, as shown in FIG. 3, a low-priority workload 328 may be turned down when a multi-tier datacenter statically allocates high-quality assets 210 and low-quality facility assets 310 (collectively “supply”) to workloads (demand), which include high-priority workload 322, medium-priority workload 324, low-priority workload 326.

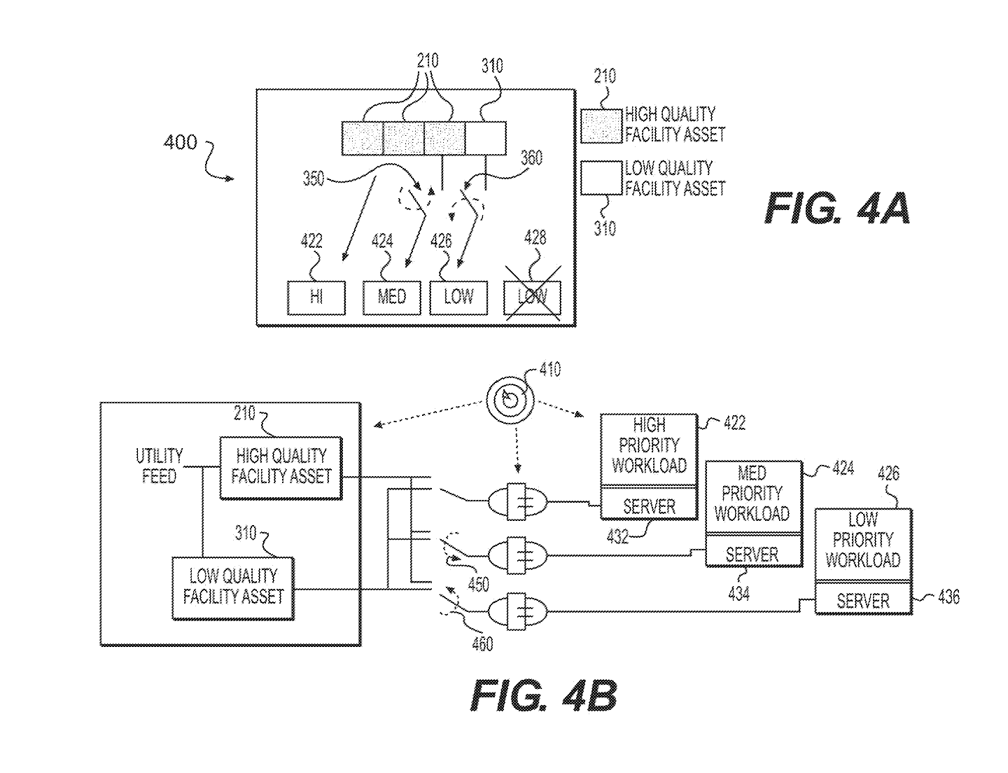

FIGS. 4A and 4B illustrate an embodiment of a system 400 for dynamically allocating high-quality facility assets 210 and low-quality facility assets 310 at the datacenter level to provide power and cooling for IT workloads. With respect to power supply, the high-quality (i.e., high-cost) facility assets 210 may be, for example, uninterrupted power supply (UPS), flywheels, or other types of power supply that provide power fast. The low-quality (i.e., low-cost) facility assets 310 may be, for example, raw power, straight utility power, or other types of low-quality power supply. With respect to cooling, the high-quality facility assets 210 may be, for example, filtered, humidified, temperature controlled cooling or other types of high quality cooling. The low-quality facility assets 310 may be, for example, natural air, or other types of low-quality cooling system.

As shown in FIG. 4A, a multi-tier datacenter allocates the high-quality facility assets 210 to a high-priority workload 422, and allocates any excess supply of the high-quality facility assets 210 to a medium-priority workload 424 and a low-priority workload 426. Another low-priority workload 428 may be supplied with the low-quality facility assets 310 or may not be supplied with power or cooling. When the demand for the high-quality facility assets 210 exceeds supply, the multi-tier datacenter may reallocate the assets 210, 310 by, for example, switching 350, 360 the medium-priority workload 424 and the low-priority workload 426, respectively, from the high-quality facility assets 210 to the low-quality facility assets 310, as shown in FIG. 4A.

Referring to FIG. 4B, an actuator 410 is provided with information on the priority of the workloads, such as high-priority workload 422, medium-priority workload 424, low-priority workload 426, and their respective servers, 432, 434, 436. The actuator 410 also monitors the amount of resources the workloads demand and tracks the total capacities of the facility assets, including the high-quality facility assets 210 (e.g., UPS and temperature controlled cooling) and the low-quality facility assets 310 (e.g., straight utility power and natural air).

After the high-quality facility assets 210 are over-burdened with high demand (e.g., UPS or temperature controlled cooling fails), the actuator 410 may switch 460 the low-priority workload 426 from the high-quality facility assets 210 (e.g., UPS and temperature controlled cooling) to the low-quality facility assets 310 (e.g., straight utility power and natural air), as shown in FIG. 4B. If the high-quality facility assets 210 are still over-burdened, the actuator 410 may also switch 450 the medium-priority workload 424 from the high-quality facility assets 210 to the low-quality facility assets 310.

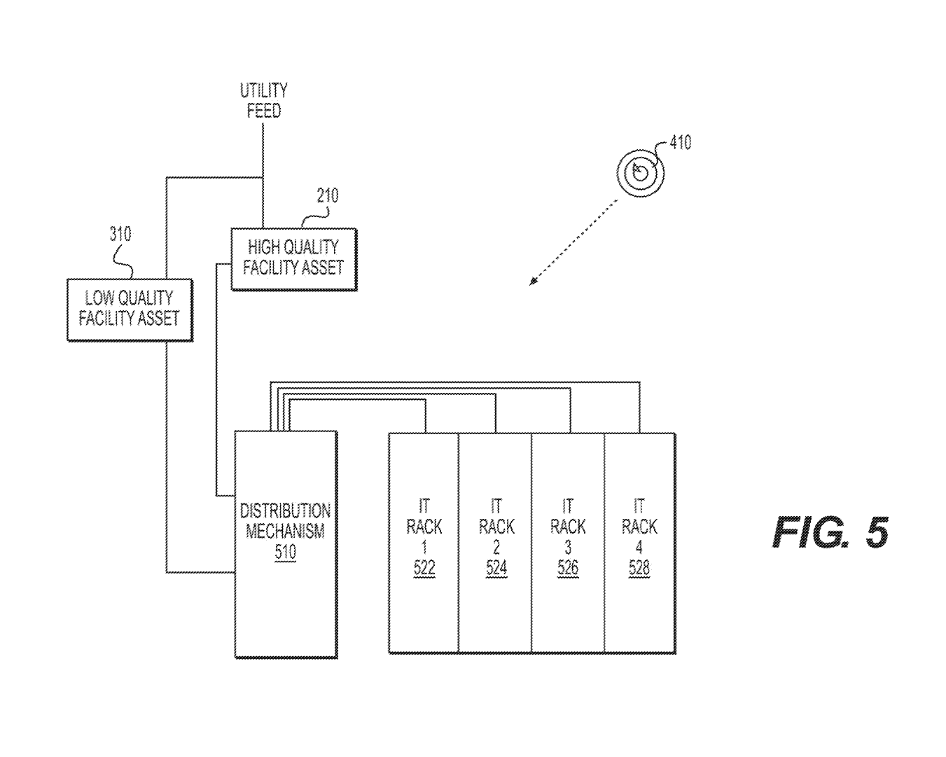

FIG. 5 illustrates another embodiment of the system 400 for dynamically allocating the high-quality facility assets 210 (e.g., UPS and temperature controlled cooling) and the low-quality facility assets 310 (e.g., straight utility power and natural air) at the datacenter level. Both the high-quality facility assets 210 and the low-quality facility assets 310 may be fed into a distribution mechanism 520, such as a power distribution rack (PDR). Based on the direction of the actuator 410, the distribution mechanism 510 may switch the facility assets supplied to the IT racks 522, 524, 526, 528 from the high-quality facility assets 210 to the low-quality facility assets 310 on the fly depending on the availability and demand of the high-quality facility assets 210.

An embodiment of the system 400 allows for active control on the supply side to dynamically reallocate and reapportion high-quality facility assets, such as conditioned, backed-up power (e.g., UPS), to the most important workloads. Lower priority workloads may be shifted off of the UPS resources and onto less conditioned and cheaper power on the fly when the UPS resources become over-subscribed due to newly added workloads. Similarly, when a UPS fails, an embodiment of the system 400 dynamically reallocates the UPS resources by switching the lower priority workloads off of the UPS resources. As a result, low-priority workloads are not burdened with the extra cost of provisioning for mission-critical workloads.

An embodiment of the system 400 fits nicely into the hybrid tier model being advanced by existing infrastructures.

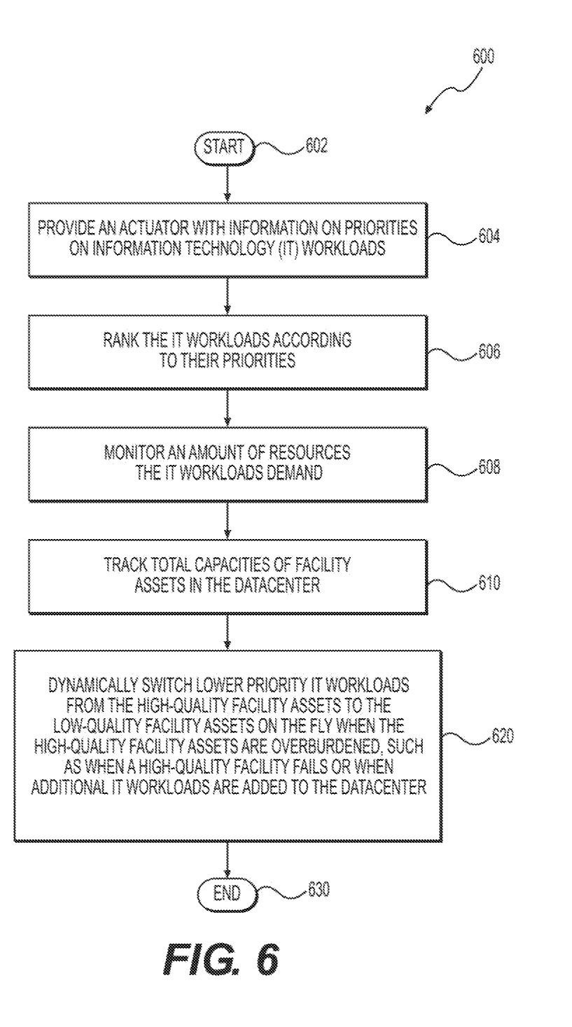

FIG. 6 is a flow chart illustrating an embodiment of a method 600 for dynamically allocating the high-quality facility assets 210 and the low-quality facility assets 310 at the datacenter level. The method 600 starts by providing an actuator with information on priorities of IT workloads (block 604). The method 600 ranks the IT workloads according to their priorities (block 606), monitors an amount of resources the IT workloads demand (block 608), and tracks total capacities of facility assets in the datacenter (block 610). The method 600 dynamically switches lower priority IT workloads from the high-quality facility assets to the low-quality facility assets on the fly when the high-quality facility assets are overburdened, such as when a high-quality facility fails or when additional IT workloads are added to the datacenter (block 620). The method 600 ends at block 630.

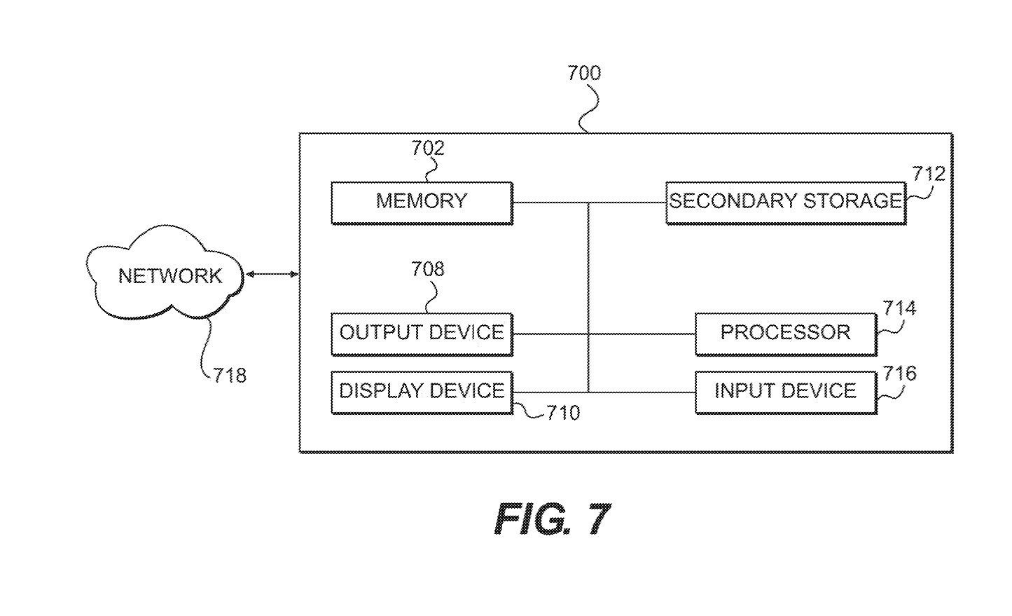

FIG. 7 illustrates exemplary hardware components of a computer 700 that may be used in connection with the method for dynamically allocating the high-quality facility assets 210 and the low-quality facility assets 310 at the datacenter level. The computer 700 includes a connection with the network 718 such as the Internet or other type of computer or telephone network. The computer 700 typically includes a memory 702, a secondary storage device 712, a processor 714, an input device 716, a display device 710, and an output device 708.

The memory 702 may include random access memory (RAM) or similar types of memory. The secondary storage device 712 may include a hard disk drive, floppy disk drive, CD-ROM drive, flash memory, or other types of non-volatile data storage, and may correspond with various databases or other resources. The processor 714 may execute instructions to perform the method steps described herein. For example, the processor 714 executes instructions to monitor the amount of resources the workloads demand and to track the total capacities of the facility assets, including the high-quality facility assets 210 and the low-quality facility assets 310. These instructions may be stored in the memory 702, the secondary storage 712, or received from the Internet or other network. The input device 716 may include any device for entering data into the computer 700, such as a keyboard, keypad, cursor-control device, touch-screen (possibly with a stylus), or microphone. The display device 710 may include any type of device for presenting a visual image, such as, for example, a computer monitor, flat-screen display, or display panel. The output device 708 may include any type of device for presenting data in hard copy format, such as a printer, and other types of output devices including speakers or any device for providing data in audio form. The computer 700 can possibly include multiple input devices, output devices, and display devices.

Although the computer 700 is depicted with various components, one skilled in the art will appreciate that the computer 700 can contain additional or different components. In addition, although aspects of an implementation consistent with the method for dynamically allocating high-quality and low-quality facility assets at the datacenter level are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer 700 to perform a particular method.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for dynamically allocating high-quality and low-quality facility assets at the datacenter level, the method being implemented by a computer including a processor and a memory, the method comprising:
providing an actuator with information on priorities of information technology (IT) workloads;
ranking the IT workloads according to their priorities, using the processor;
the actuator monitoring an amount of resources the IT workloads demand, using the processor;
the actuator tracking total capacities of facility assets in the datacenter, using the processor, wherein the facility assets include high-quality facility assets and low-quality facility assets; and
dynamically switching lower priority IT workloads from the high-quality facility assets to the low-quality facility assets when the high-quality facility assets are overburdened.

2. The method of claim 1, further comprising dynamically switching the lower priority IT workloads from the high-quality facility assets to the low-quality facility assets when a high-quality facility fails.

3. The method of claim 1, further comprising dynamically switching the lower priority IT workloads from the high-quality facility assets to the low-quality facility assets on the fly when additional IT workloads are added to the datacenter.

4. The method of claim 1, wherein the high-quality facility assets include uninterrupted power supply (UPS).

5. The method of claim 1, wherein the high-quality facility assets include temperature controlled cooling.

6. The method of claim 1, wherein the low-quality facility assets include straight utility power.

7. The method of claim 1, wherein the low-quality facility assets include natural air.

8. The method of claim 1, wherein the IT workloads include high-priority IT workloads; medium-priority IT workloads, and low-priority IT workloads, and wherein the actuator switches the low-priority IT workloads off of the high-quality facility assets before switching the medium-priority IT workloads off of the high-quality facility assets.

9. A system for dynamically allocating high-quality and low-quality facility assets at the datacenter level, the system being implemented by a computer including a processor and a memory, the system comprising:
an actuator that ranks information technology (IT) workloads according to priorities of the IT workloads, wherein the actuator monitors an amount of resources the IT workloads demand, and tracks total capacities of facility assets in the datacenter, wherein the facility assets include high-quality facility assets and low-quality facility assets; and
a distribution mechanism that dynamically switches lower priority IT workloads from the high-quality facility assets to the low-quality facility assets when the high-quality facility assets are overburdened.

10. The system of claim 9, wherein the distribution mechanism dynamically switches the lower priority IT workloads from the high-quality facility assets to the low-quality facility assets when a high-quality facility fails.

11. The system of claim 9, wherein the distribution mechanism dynamically switches the lower priority IT workloads from the high-quality facility assets to the low-quality facility assets on the fly when additional IT workloads are added to the datacenter.

12. The system of claim 9, wherein the high-quality facility assets include uninterrupted power supply (UPS).

13. The system of claim 9, wherein the high-quality facility assets include temperature controlled cooling.

14. The system of claim 9, wherein the low-quality facility assets include straight utility power.

15. The system of claim 9, wherein the low-quality facility assets include natural air.

16. The system of claim 9, wherein the IT workloads include high-priority IT workloads, medium-priority IT workloads, and low-priority IT workloads, and wherein the actuator switches the low-priority IT workloads off of the high-quality facility assets before switching the medium-priority IT workloads off of the high-quality facility assets.

17. A computer readable medium providing instructions for dynamically allocating high-quality and low-quality facility assets at the datacenter level, the instructions comprising:
providing an actuator with information on priorities of information technology (IT) workloads;
ranking the IT workloads according to their priorities, using the processor;
the actuator monitoring an amount of resources the IT workloads demand, using the processor;
the actuator tracking total capacities of facility assets in the datacenter, using the processor, wherein the facility assets include high-quality facility assets and low-quality facility assets; and
dynamically switching lower priority IT workloads from the high-quality facility assets to the low-quality facility assets when the high-quality facility assets are overburdened.

18. The computer readable medium of claim 17, further comprising instructions for dynamically switching the lower priority IT workloads from the high-quality facility assets to the low-quality facility assets when a high-quality facility fails.

19. The computer readable medium of claim 17, further comprising instructions for dynamically switching the lower priority IT workloads from the high-quality facility assets to the low-quality facility assets on the fly when additional IT workloads are added to the datacenter.

20. The computer readable medium of claim 17, wherein the IT workloads include high-priority IT workloads, medium-priority IT workloads, and low-priority IT workloads, and wherein the instructions include the actuator switching the low-priority IT workloads off of the high-quality facility assets before switching the medium-priority IT workloads off of the high-quality facility assets.
